(19) United States
(12) Patent Application Publication
(10) Pub. No.: US 2007/0052363 A1
(43) Pub. Date: Mar. 8, 2007

(54) High-pressure discharge lamp

(75) Inventor: Klaus Schöller, eindhoven (NL)

Correspondence Address: PHILIPS INTELLECTUAL PROPERTY & STANDARDS, P.O. BOX 3001, BRIARCLIFF MANOR, NY, 10510, US

(73) Assignee: koninkijkle phillips electronics n.v.

(21) Appl. No.: 10/539,695

(22) PCT Filed: Dec. 5, 2003
(86) PCT No.: PCT/IB03/05778

§ 371 Date: Jun. 16, 2005

(30) Foreign Application Priority Data
Dec. 17, 2002 (EP) 02102783.4

(51) Int. Cl. H01J 17/04

(52) U.S. Cl. 313/633

(57) ABSTRACT

A high-pressure discharge lamp (1) comprising at least one burner (2) having a discharge space, and comprising two electrodes extending in said discharge space, a gas filling in the discharge space containing at least an inert gas and a suitable metal halide mixture, and comprising an outer bulb (3) which is attached to the burner (2) and the basic material of which is doped with an absorbing material, the high-pressure discharge lamp (1) comprising at least one interference filter (6) which reflects predominantly in the wavelength range of 400 to 550 nm, and which is arranged directly on at least a part of the outer surface of the outer bulb (3), and the outer bulb (3) being doped with a material that is absorbing for wavelengths <550 nm.

The present invention relates to a high-pressure discharge lamp comprising at least one burner having a discharge space, and comprising two electrodes extending in said discharge space, a gas filling in the discharge space containing at least an inert gas and a suitable metal halide mixture, and comprising an outer bulb which is attached to the burner and the basic material of which is doped with absorbing material.

This high-pressure discharge lamp comprising an outer bulb can suitably be used for general lighting purposes. Said high-pressure discharge lamp is particularly suited for use as a headlight lamp in a vehicle, such as a motorcar.

A discharge lamp of said type comprising an inner bulb and an outer bulb is known from EP 0 964 431 B 1. The discharge lamp described therein comprises an arc tube having a light-emitting region provided with an electrode pair, and an outer tube surrounding said light-emitting region and being at least partly fused to the arc tube, said outer tube comprising silicon dioxide (SiO₂) as the main constituent and, in addition, boron.

U.S. Pat. No. 5,248,638 discloses a high-temperature glass to be used for car lights emitting a more yellow light that is visible to the human eye. This high-temperature glass contains chromium or oxides of chromium, in particular Cr₂O₃, as well as zinc oxide which serves to stabilize the chromium in the high-temperature glass.

The use of oxides of chromium has the drawback, however, that the lumen output of the light emitted by such discharge lamps is reduced significantly as the quantity of doped chromium increases.

WO 01/24224 A1 discloses a halogen lamp having light-absorbing properties. This lamp comprises, in this connection, a light-absorbing means and an interference filter, which interference filter is arranged on the outer surface of the lamp bulb, and the absorbing layer must be situated, for functional reasons, between the lamp bulb and the interference filter. Due to said combination of a light-absorbing means and an interference filter, which both operate, in particular, in the wavelength range of 570 to 620 nm, the emitted visible light contains a superproportional fraction of amber-colored light.

Transferring the above-mentioned solution to the discharge vessel of a high-pressure discharge lamp is impossible, particularly with regard to the higher operating temperature of this lamp.

A drawback of the discharge lamps in accordance with the state of the art is that the color point of the emitted light in accordance with the CIE 1931 diagram does not lie in the so-termed “front fog” range in accordance with ECE R99. In addition, the discharge lamps in accordance with the state of the art often exhibit a poor light output (lm/Watt) and too short a service life.

It is an object of the present invention to provide a high-pressure discharge lamp having a color temperature of the emitted light below 3000 K, the color point of the emitted light lying within the “front fog” range in accordance with ECE R99, and the lamp exhibiting a light output of at least 60 lm/Watt and having improved service life characteristics.

In the case of the yellow light in accordance with the invention, the color characteristics must lie within the range defined by the following limiting values:

| | |
|---|---|
| towards red | y > 0.138 + 0.580 x |
| towards green | y < 1.29 x − 0.100 |
| towards white | y > −x + 0.940 and y > 0.440 |
| towards the spectrum locus | y < −x + 0.992. |

If the term “front fog” is used within the context of the invention, it is to be taken to mean the yellow color in accordance with the CIE 1931 of the yellow range of the corresponding diagram.

The object of the invention is achieved by a high-pressure discharge lamp comprising at least one interference filter which reflects predominantly in the wavelength range of 400 to 550 nm and which is arranged directly on at least a part of the outer surface of the outer bulb, which outer bulb is doped with a material that is absorbing for wavelengths <550 nm.

An ionizing gas filling in accordance with the invention comprises at least an inert gas as well as mercury in the range of 0 mg to 10 mg.

A lower color temperature in the “front fog” range enables the vision of the driver of the vehicle to be improved, in particular, under bad weather conditions such as fog. The visible yellow light emitted by means of the high-pressure discharge lamp in accordance with the invention is better adapted to the natural sensitivity of the human eye, so that overstressing in this connection and the associated fatigue are precluded. As a result, in particular a higher traffic safety is achieved.

In addition, the high-pressure discharge lamp in accordance with the invention also enables a good light output (lm/Watt) to be attained. For example, the light output of the light emitted by such a high-pressure discharge lamp is at least 60 lm/Watt, preferably ≧70 lm/Watt. Moreover, by means of the high-pressure discharge lamps in accordance with the invention, also light outputs ≧80 lm/Watt and higher can be achieved.

Advantageous embodiments of the high-pressure discharge lamp in accordance with the invention are apparent from claims 2 through 10.

Preferably, the basic material of the outer bulb is predominantly composed of SiO₂ and contains Cr, Zn, Fe, Sb, Ti or Cr oxide, preferably up to 0.7%, Zn oxide, preferably up to 1.0%, Al oxide, preferably Al₂O₃, Fe oxide, Sb oxide, Ti oxide and/or their mixtures. The addition of chromium or chromium oxide is also advantageous as UV protection.

It is alternatively preferred that the basic material of the outer bulb comprises at least 0.024 to 0.5% Cr₂O₃ as well as 0.034 to 1.0% of ZnO and Al₂O₃, with a view to stabilizing the glass, in the range of 0.03 to 1.0%.

In accordance with a preferred embodiment, on a tubular outer bulb having two ends at least one of which is connected to the burner, (cf. German text Aussenkolben should be read as Brenner) at least at the surfaces of the regions that are used to attach the burner to the outer bulb, no light-absorbing means and/or interference filters are provided. By virtue thereof, the high-pressure discharge lamp can be more effectively produced in a large-scale manufacturing process.

In a further modification of the above-mentioned embodiment, it is preferred that, with regard to the wavelength range of 600 to 800 nm, the light transmittance of the materials of the outer bulb is >60% and the light transmittance of the interference filter is >90%. It is thus achieved that the desired yellow light having a sufficient light intensity is made available.

In respect of an effective manufacture and functionality of the interference filter, it is preferred that the thickness of the entire filter ranges between 800 and 2800 nm.

The interference filter usually has a multilayer structure, said multilayer structure being such that a layer having a higher refractive index alternates with a layer having a lower refractive index. In this connection, the layer having the lower refractive index efficaciously comprises predominantly SiO₂ and the second layer comprises a material having a higher refractive index than SiO₂. Said second layer is preferably composed of a material selected from the group consisting of titanium oxide, tantalum oxide, niobium oxide, hafnium oxide, silicon nitride, very preferably zirconium oxide (ZrO₂), or a mixture of these materials.

The object of the invention is further achieved in that a light system for motorcars comprising at least a high-pressure discharge lamp as claimed in claims 1 to 10 is provided.

The high-pressure discharge lamp in accordance with the invention may be used for general lighting purposes. Said high-pressure discharge lamp may particularly be used as a light source in, for example, means of transport such as aircraft, motor vehicles, motorbikes or the like. The high-pressure discharge lamp in accordance with the invention is particularly preferably used for headlights, in particular for illumination headlights in motor vehicles such as motorcars.

These and other aspects of the invention are apparent from and will be elucidated with reference to the embodiment(s) described hereinafter.

In the drawings:

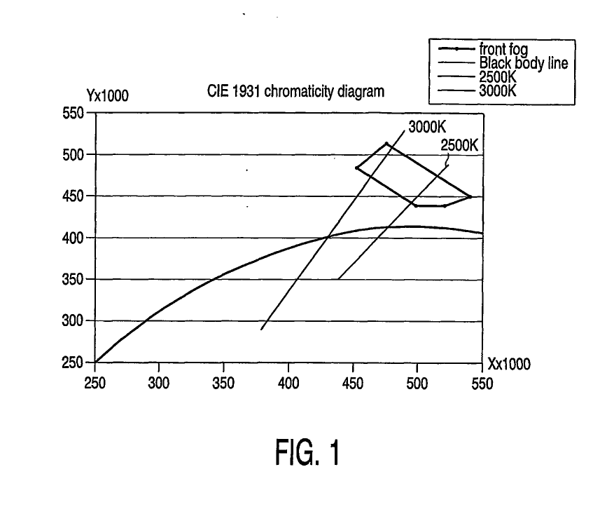

FIG. 1 shows a CIE 1931 chromaticity diagram

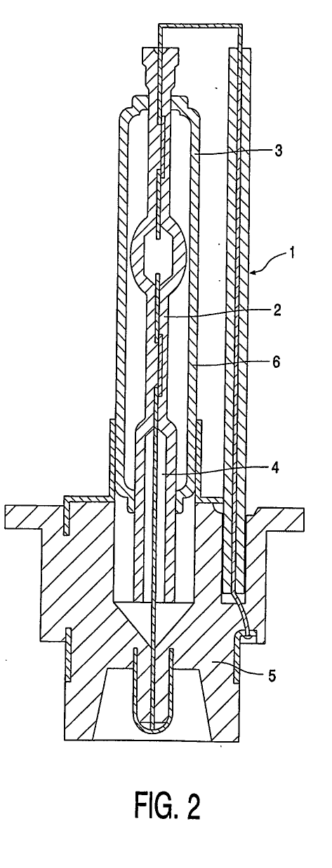

FIG. 2 shows a customary high-pressure discharge lamp comprising a burner and an outer bulb.

In FIG. 1, the spectral range in accordance with the invention, which corresponds to the ECE R99 standard for “front fog” light, is shown as a plane in the diagram. The color temperatures, also referred to as “correlated color temperature”, i.e. in this case the two lines of equal color temperature of 3000 K and 2500 K, respectively, are partly situated inside this plane. As is shown in the diagram, the color location of the high-pressure lamp in accordance with the invention lies above the line of the black body radiation.

FIG. 2 shows a high-pressure discharge lamp comprising a burner 2 and an outer bulb 3. Said burner 2, which is customary per se and is made predominantly of quartz glass comprises a discharge space filled with an ionizing gas mixture comprising at least an inert gas and a metal halide mixture containing at least 40 to 80 wt. % NaI, 0 to 40 wt. % ScI and 0 to 60 wt. % TI. In the discharge space, two electrodes with respective electrical contacts are arranged in a customary manner. The outer bulb 3 is doped with a material that is absorbing for wavelengths <550 nm, i.e. said material comprising at least 0.024 to 0.5% Cr₂O₃, 0.034 to 1.0% Al₂O₃and ZnO. The burner 2 is attached to the lower end 4 of the tubular outer bulb 3, at least the surfaces of the regions used for attaching the burner 2 to the outer bulb 3 being free of light-absorbing means and/or interference filters. A multilayer interference filter 6 that reflects substantially in the wavelength range of 400 to 550 nm is provided directly on the outer surface of the outer bulb 3, at least the greater part of the outer surface of the outer bulb 3 being covered by the interference filter 6. The interference filter 6 is embodied so as to be multilayered, the multilayer structure being such that a layer having a higher refractive index alternates with a layer having a lower refractive index. The layer having the lower refractive index is predominantly composed of SiO₂, and the second layer is composed of zirconium oxide (ZrO₂), which materials are temperature-stable in the 900° C. range, and zirconium oxide has a higher refractive index than SiO₂. The individual layers are formed by means of a customary thin-film process, such as a so-termed PVD process.

The lamp comprises a customary base 5, so that the lamp can be replaceably mounted in a front headlight of a motorcar.

A light system for motorcars comprising such a high-pressure discharge lamp in accordance with the invention enables a light output of approximately 86 lm/Watt to be attained. The color location in the CIE 1931 diagram (“chromaticity diagram”) can be sufficiently specified by means of the values of the two co-ordinates, i.e. X is approximately 0.48 and Y is approximately 0.48. The service life of a high-pressure discharge lamp in accordance with the invention is at least 1500 hours.

1. A high-pressure discharge lamp (1) comprising at least
a burner (2) having a discharge space,
two electrodes extending in said discharge space,
a gas filling in the discharge space comprising at least an inert gas and a suitable metal halide mixture, and
an outer bulb (3) which is attached to the burner (2) and the basic material of which is doped with absorbing material, characterized in that the high-pressure discharge lamp (1) comprises at least one interference filter (6) which reflects predominantly in the wavelength range of 400 to 550 nm and which is arranged directly on at least a part of the outer surface of the outer bulb (3), which outer bulb (3) is doped with a material that is absorbing for wavelengths <550 nm.

2. A high-pressure discharge lamp (1) as claimed in claim 1, characterized in that the basic material of the outer bulb (3) is predominantly composed of SiO₂ and contains Cr, Zn, Fe, Sb, Ti or Cr oxide, with chromium being in the trivalent state as CrIII, or predominantly in the hexavalent state as CrVI, preferably in a quantity up to 0.7%, Zn oxide, preferably 1.0%, Al oxide, preferably Al₂O₃, Fe oxide, Sb oxide, Ti oxide and/or their mixtures.

3. A high-pressure discharge lamp (1) as claimed in claim 1, characterized in that the basic material of the outer bulb (3) comprises at least 0.024 to 0.5% Cr₂O₃, 0.034 to 1.0% ZnO and Al₂O₃.

4. A high-pressure discharge lamp (1) as claimed in claim 1, characterized in that a tubular outer bulb (3) is attached, at least with one end, to the burner (2), and at least at the surfaces of the regions that are used to attach the burner (2) to the outer bulb (3), no light-absorbing means and/or interference filters (6) are provided.

5. A high-pressure discharge lamp (1) as claimed in claim 1, characterized in that with regard to the wavelength range of 600 to 800 nm, the light transmittance of the materials of the outer bulb (3) is >60% and the light transmittance of the interference filter (6) is >90%.

6. A high-pressure discharge lamp (1) as claimed in claim 1, characterized in that the overall layer thickness of the interference filter (6) ranges between 800 and 2800 nm.

7. A high-pressure discharge lamp (1) as claimed in claim 1, characterized in that the interference filter (6) is composed of a plurality of layers, the layer structure being such that a layer having a higher refractive index alternates with a layer having a lower refractive index, the layer having the lower refractive index preferably being predominantly composed of SiO₂ and the second layer being composed of a material having a higher refractive index than SiO₂, said layer preferably being composed of ZrO₂.

8. A high-pressure discharge lamp (1) as claimed in claim 7, characterized in that the second layer is composed of a material selected from the group consisting of titanium oxide, tantalum oxide, niobium oxide, hafnium oxide, silicon nitride, very preferably zirconium oxide ZrO₂, or a mixture of these materials.

9. A high-pressure discharge lamp (1) as claimed in claim 1, characterized in that the metal halide mixture is composed of 40 to 80 wt. % NaI, 0 to 40 wt. % ScI and 0 to 60 wt. % TI.

10. A high-pressure discharge lamp (1) as claimed in claim 1, characterized in that the lumen output of the light emitted by the high-pressure discharge lamp (1) is at least 60 lm/W, preferably at least 70 lm/W and very preferably at least 80 lm/W.

11. A light system for motorcars comprising at least a high-pressure discharge lamp (1) as claimed in claim 1.
